(19) United States
(12) Patent Application Publication
(10) Pub. No.: US 2013/0015648 A1
(43) Pub. Date: Jan. 17, 2013

(54) SEAT BELT APPARATUS FOR VEHICLE

(71) Applicant: Choong Sik Shin, Anyang-si (KR)

(72) Inventor: Choong Sik Shin, Anyang-si (KR)

(73) Assignee: Hyundai Motor Company, Seoul (KR)

(21) Appl. No.: 13/292,697

(22) Filed: Nov. 9, 2011

(30) Foreign Application Priority Data
Jul. 12, 2011 (KR) 10-2011-0068921

(51) Int. Cl. B60R 22/46

(52) U.S. Cl. 280/806

(57) ABSTRACT

A seat belt apparatus for a vehicle may include a seat belt sectioned into a shoulder webbing and a lap webbing, based on a buckle tongue, and a retractor-integrated pretensioner fastened to a vehicle body, the retractor-integrated pretensioner being configured such that an end of the shoulder webbing and an end of the lap webbing may be wound up or unwound together by the retractor-integrated pretensioner, and when a vehicle accident occurs, the retractor-integrated pretensioner simultaneously winds up the shoulder webbing and the lap webbing.

### CROSS-REFERENCE TO RELATED APPLICATION

The present application claims priority to Korean Patent Application No. 10-2011-0068921, filed on Jul. 12, 2011, the entire contents of which is incorporated herein for all purposes by this reference.

### BACKGROUND OF THE INVENTION

1. Field of the Invention

The present invention relates generally to seat belt apparatuses for vehicles and, more particularly, to a seat belt apparatus for a vehicle which has a reduced number of parts, thus reducing the production cost and the weight of the apparatus.

2. Description of Related Art

Generally, a seat belt apparatus for a vehicle supports the upper body of a user sitting on a seat to protect the user in case of an accident involving a vehicle, such as a collision or a rear-end collision. FIG. 1 shows a representative example of conventional seat belt apparatuses which are provided in driver seats or passenger seats. As shown in FIG. 1, the conventional seat belt apparatus includes a seat belt 2, a retractor pretensioner 3, and an anchor pretensioner 4. Based on a buckle tongue 1, the seat belt 2 is sectioned into a shoulder webbing 2a which holds a shoulder and chest of a user sitting on a seat, and a lap webbing 2b which holds the hip and the lower part of the body of the user. The retractor pretensioner 3 is connected to the end of the shoulder webbing 2a so that when a vehicle accident occurs, the retractor pretensioner 3 holds the shoulder webbing 2a. The anchor pretensioner 4 is connected to the end of the lap webbing 2b so that when the vehicle accident occurs, the anchor pretensioner 4 holds the lap webbing 2b.

The shoulder webbing 2a passes through a belt ring 5 having a D shape. The belt ring 5 is fastened to an upper end of a center pillar.

The retractor pretensioner 3 is fastened to a vehicle body and located inside the center pillar such that it is not exposed to the passenger compartment. The anchor pretensioner 4 is fastened to a portion of the vehicle body corresponding to a lower end of the center pillar and protrudes into the passenger compartment.

In the conventional seat belt apparatus having the above-mentioned construction, when a vehicle accident occurs, the shoulder webbing 2a and the lap webbing 2b are individually wound up by the interlocking operation of the retractor pretensioner 3 and the anchor pretensioner 4. Thereby, the seat belt 2 is rapidly wound up, thus increasing the force with which the seat belt 2 holds the user who is sitting on the seat.

However, to individually wind up the shoulder webbing 2a and the lap webbing 2b, both the retractor pretensioner 3 and the anchor pretensioner 4 must be used, resulting in an increase in the number of parts. This increases the production cost and the weight of the apparatus.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a seat belt apparatus for a vehicle which is configured such that when a vehicle accident occurs, a single retractor-integrated pretensioner winds up a shoulder webbing and lap webbing at the same time, thus reducing the number of pretensioners that are used, thereby reducing the production cost and the weight of the apparatus.

In an aspect of the present invention, the seat belt apparatus for a vehicle may include a seat belt sectioned into a shoulder webbing and a lap webbing, based on a buckle tongue, and a retractor-integrated pretensioner fastened to a vehicle body, the retractor-integrated pretensioner being configured such that an end of the shoulder webbing and an end of the lap webbing may be wound up or unwound together by the retractor-integrated pretensioner, and when a vehicle accident occurs, the retractor-integrated pretensioner simultaneously winds up the shoulder webbing and the lap webbing.

The shoulder webbing passes through an upper belt ring fastened to an upper end of a center pillar.

The lap webbing passes through a lower belt ring fastened to a lower end of a center pillar.

The retractor-integrated pretensioner may include a housing fastened to the vehicle body, and a spool rotatably provided in the housing and connected both to the end of the webbing and the end of the lap webbing.

The housing may be located in an interior of the center pillar so that the housing may be prevented from being exposed to a passenger compartment of the vehicle.

The spool may include a single spool, and both the end of the webbing and the end of the lap webbing may be connected to the single spool.

An actuator may be connected to the spool and an electronic control unit controls the actuator to selectively rotate the spool

In a seat belt apparatus for a vehicle according to the present invention, a shoulder webbing and a lap webbing can be wound or unwound at the same time by a single retractor-integrated pretensioner including a single spool. Hence, the number of parts is reduced, thus reducing the production cost and the weight of the apparatus.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a conventional seat belt apparatus.

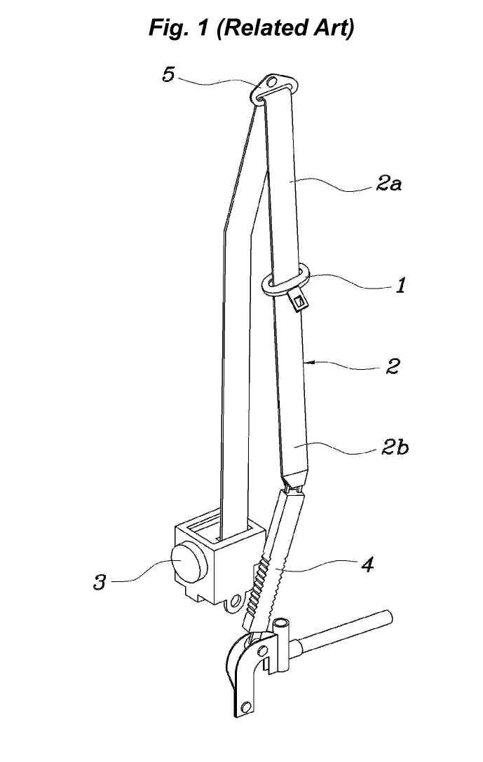

FIG. 2 is a perspective view of a seat belt apparatus, according to an exemplary embodiment of the present invention.

FIGS. 3 and 4 are respectively a side view and a front view of a retractor-integrated pretensioner according to an exemplary embodiment of the present invention.

FIG. 5 is a view showing the retractor-integrated pretensioner of FIG. 3, from which a housing was removed.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a exemplary embodiment of the present invention will be described in detail with reference to the attached drawings.

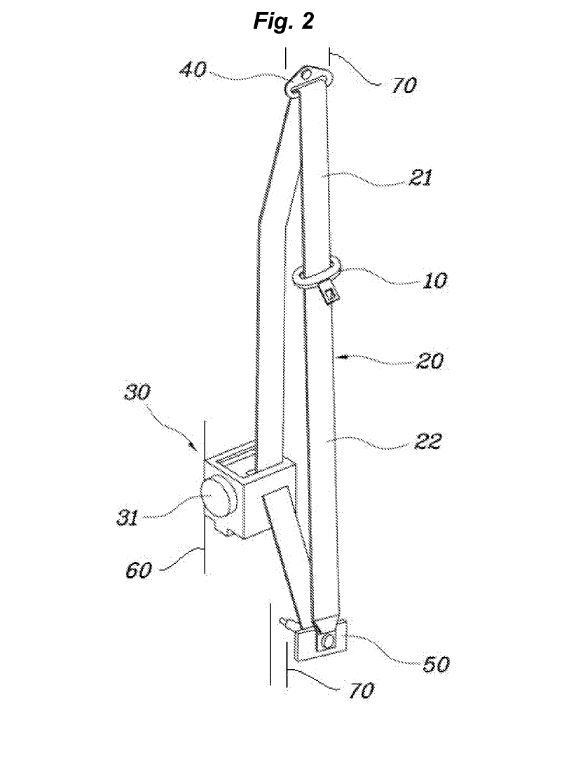

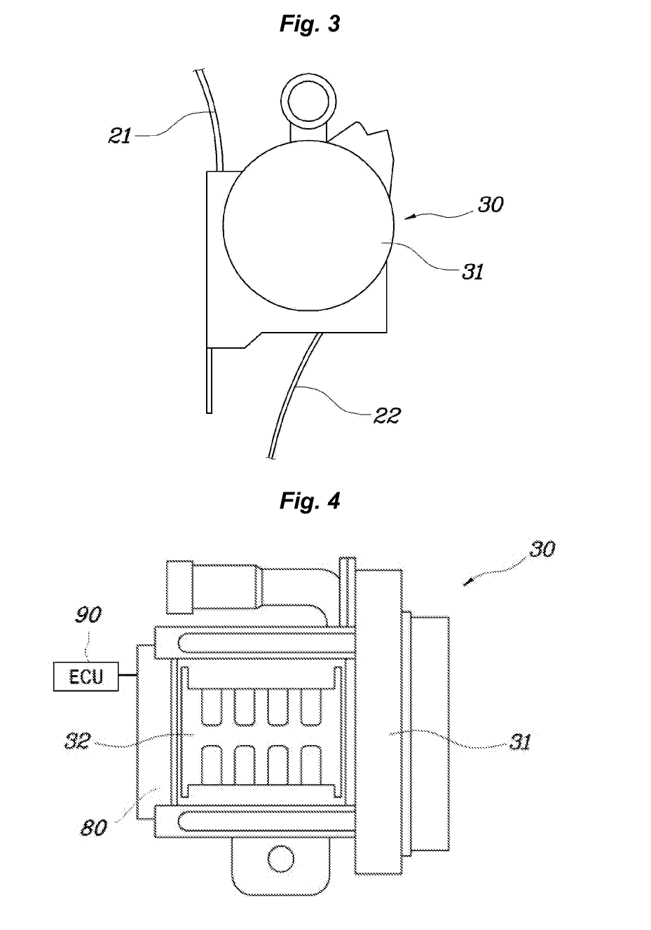

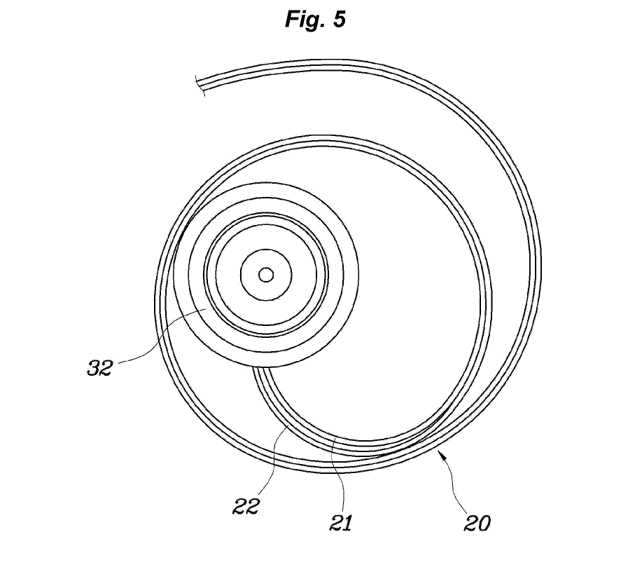

As shown in FIGS. 2 through 5, a seat belt apparatus for a vehicle according to an exemplary embodiment of the present invention includes a seat belt 20 and a retractor-integrated pretensioner 30. Based on a buckle tongue 10, the seat belt 20 is sectioned into a shoulder webbing 21 which holds a shoulder and the chest of a user sitting on a seat, and a lap webbing 22 which holds the hip and the lower part of the body of the user. The retractor-integrated pretensioner 30 is fastened to a vehicle body 60 and is configured such that a corresponding end of the shoulder webbing 21 and a corresponding end of the lap webbing 22 are wound up together by the retractor-integrated pretensioner 30, and when a vehicle accident occurs, the retractor-integrated pretensioner 30 winds up the shoulder webbing 21 and the lap webbing 22 at the same time.

The shoulder webbing 21 passes through an upper belt ring 40, and the lap webbing 22 passes through a lower belt ring 50.

Each of the upper and lower belt rings 40 and 50 has a D shape. The upper belt ring 40 and the lower belt ring 50 function to respectively prevent the shoulder webbing 21 and the lap webbing 22 from sagging and to respectively guide movement of the shoulder webbing 21 and the lap webbing 22.

The upper belt ring 40 and the lower belt ring 50 are respectively fastened to an upper end and a lower end of a center pillar 70 and are exposed to the passenger compartment of the vehicle.

Meanwhile, the retractor-integrated pretensioner 30 includes a housing 31 and a spool 32. The housing 31 is fastened to the vehicle body 60 and is located in the interior of the center pillar so that it is prevented from being exposed to the passenger compartment of the vehicle. The spool 32 is rotatably provided in the housing 31 and is connected both to the end of the webbing 21 and the end of the lap webbing 22.

That is, the retractor-integrated pretensioner 30 includes just the single spool 32 and is configured such that both the end of the shoulder webbing 21 and the end of the lap webbing 22 are connected to the single spool 32.

The operation of the seat belt apparatus according to an exemplary embodiment of the present invention will be explained below.

When the user who is sitting on the seat pulls the seat belt 20 to put it on, the shoulder webbing 21 and the lap webbing 22 are unwound from the single spool 32 of the retractor-integrated pretensioner 30 at the same time while the spool 32 rotates. On the contrary, when the buckle tongue 10 is removed from a buckle to unfasten the seat belt 20, the shoulder webbing 21 and the lap webbing 22 are wound at the same time around the spool 32 of the retractor-integrated pretensioner 30.

Furthermore, when a vehicle accident occurs, the retractor-integrated pretensioner 30 is operated by a control signal transmitted from an electronic control unit 90 to control a motor 80 connected to the spool 32 to rapidly rotate the spool 32 so that the shoulder webbing 21 and the lap webbing 22 are wound at the same time around the spool 32.

Therefore, in the same manner as the conventional technique, the present invention exhibits the function of reliably holding the user when a vehicle accident occurs. However, in an exemplary embodiment of the present invention, both the shoulder webbing 21 and the lap webbing 22 are rapidly wound around the single spool 32 of the retractor-integrated pretensioner 30 at the same time, unlike the conventional technique.

As described above, in an exemplary embodiment of the present invention, the operation of winding or unwinding the shoulder webbing 21 and the lap webbing 22 is embodied by the single retractor-integrated pretensioner 30. Therefore, the present invention is advantageous in that the number of parts is reduced compared to the conventional seat belt apparatus including the retractor pretensioner 3 and the anchor pretensioner 4. Thereby, the production cost and the weight of the apparatus can be reduced.

Furthermore, the present invention is configured such that the shoulder webbing 21 and the lap webbing 22 are wound around the single spool 32 at the same time. Therefore, compared to the conventional technique using two spools to wind up the shoulder webbing and the lap webbing, there is an advantage in that the number of spools is reduced. As a result, the production cost and the weight of the apparatus can be further reduced.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat belt apparatus for a vehicle, comprising:
a seat belt sectioned into a shoulder webbing and a lap webbing, based on a buckle tongue; and
a retractor-integrated pretensioner fastened to a vehicle body, the retractor-integrated pretensioner being configured such that an end of the shoulder webbing and an end of the lap webbing are wound up or unwound together by the retractor-integrated pretensioner, and when a vehicle accident occurs, the retractor-integrated pretensioner simultaneously winds up the shoulder webbing and the lap webbing.

2. The seat belt apparatus as set forth in claim 1, wherein the shoulder webbing passes through an upper belt ring fastened to an upper end of a center pillar.

3. The seat belt apparatus as set forth in claim 1, wherein the lap webbing passes through a lower belt ring fastened to a lower end of a center pillar.

4. The seat belt apparatus as set forth in claim 1, wherein the retractor-integrated pretensioner includes:
a housing fastened to the vehicle body; and
a spool rotatably provided in the housing and connected both to the end of the webbing and the end of the lap webbing.

5. The seat belt apparatus as set forth in claim 4, wherein the housing is located in an interior of the center pillar so that the housing is prevented from being exposed to a passenger compartment of the vehicle.

6. The seat belt apparatus as set forth in claim 4, wherein the spool includes a single spool, and both the end of the webbing and the end of the lap webbing are connected to the single spool.

7. The seat belt apparatus as set forth in claim 4, wherein an actuator is connected to the spool and an electronic control unit controls the actuator to selectively rotate the spool.
